(19) United States
(12) Patent Application Publication
(10) Pub. No.: US 2013/0292343 A1
(43) Pub. Date: Nov. 7, 2013

(54) SYSTEM AND METHOD FOR COLLECTING COMPOUNDS IN THE GROUND

(71) Applicant: Yves Durkheim, Luisant (FR)

(72) Inventor: Yves Durkheim, Luisant (FR)

(73) Assignee: AFITEX INTERNATIONAL, Chartries (FR)

(21) Appl. No.: 13/993,880

(22) PCT Filed: Dec. 14, 2011
(86) PCT No.: PCT/FR11/52984

§ 371 Date: Jul. 15, 2013

(30) Foreign Application Priority Data
Dec. 14, 2010 (FR) 1060514

(51) Int. Cl. C02F 1/62

(52) U.S. Cl. CPC C02F 1/62
USPC 210/747.7; 210/170.07

(57) ABSTRACT

The present invention relates to a system (1) and to a method for collecting chemical compound(s) in aggregate (S), characterized in that it comprises at least one surface on which is placed at least one geocomposite (2) comprising at least one draining layer (22) on which there are perforated mini-drains (23) each containing at least one chemical compound fixing filament (24), aggregate (S) being placed on said geocomposite (2) in such a way that a fluid (L), which becomes laden with chemical compound(s) as it passes through the aggregate (S), reaches the inside of said perforated mini-drains (23) in which said fixing filaments (24) collect the chemical compound(s).

The present invention relates to the field of collection systems for chemical compounds in soils. The invention applies for example to the mining field, for collection of chemical valuable compounds, such as gold or iron for example, but also to the field of decontamination of soils, for example for the collection of heavy metals. The present invention relates more particularly to a collection system for chemical compounds in aggregates such as soils, sediments, waste, etc. In general, the invention applies to any type of soluble chemical compound or which can be conveyed by fluid.

A problem in the field of collection systems for compounds in soils relates to difficult access to chemical compounds present in soils. In particular, in the field of decontamination, heavy metals present for example in soils, sludge, waste, sediments and water which percolate are difficult and costly to eliminate. These heavy metals can be of widely varying chemical nature. Similarly, in the mining field, the extraction of chemical compounds is particularly difficult, especially when they are present in the form of small-sized particles, or even in the form of ions.

Decontamination systems of heavy metals using microorganisms, plants or chemical compounds are known in the prior art. On the other hand, various types of devices collecting heavy metals are known from the prior art. When chemical compounds are present in soils, sludge, sediments, water, etc., systems of the prior art often require the soil to be handled, such as extraction and packaging in containers for example, but these are expensive and must be carried out systematically and regularly. Solutions in which the soil is extracted and mixed with various chemical compounds or solutions in which the soil is extracted and conveyed on various devices to undergo various successive treatments are known for example.

The disadvantages of solutions from the prior art generally are that they are limited in terms of treatment capacity and/or require the use of large volumes of water and/or are too expensive and/or are poorly adapted to their reuse for successive treatments. In this context, it is interesting to propose an efficacious collection system which can be reused by reducing handling.

German patent DE 44 10 612 A1 describes a drainage system with a support for drain pipe. The system comprises a plurality of layers of mineral materials on which drain pipes are deposited. The drain pipe support is installed between the layers of mineral materials and the drain pipes. A geotextile is also arranged on the layers of mineral materials and is fixed to the drain pipe support. This system does not allow collection of chemical compounds in soils.

US patent 2008/0173576 A1 describes a process for synthesising of zero-valent steel nanowires and their application to treatment of phreatic layers loaded with chromium or arsenic. The process does not allow collection of chemical compounds or drainage of soil.

The aim of the present invention is to rectify at least some disadvantages of the prior art by proposing especially a collection system for chemical compounds in soils, which is inexpensive, efficacious and reusable.

This aim is achieved by a collection system for chemical compound in aggregates, characterised in that it comprises at least one surface on which is arranged at least one geocomposite comprising at least one draining layer on which are arranged perforated mini-drains each containing at least one fixing filament of chemical compound, aggregates being deposited on said geocomposite such as fluid which is loaded with chemical compound when passing through the aggregates reaches the interior of said perforated mini-drains in which said fixing filaments collect the chemical compound(s).

According to another particular feature, said geocomposite comprises at least one filtering layer covering the perforated mini-drains so as to filter said fluid.

According to another particular feature, said geocomposite is covered, prior to deposit of the aggregates, by at least one granulate of granulometry determined as a function of the kinetic fixing speed of the chemical compounds by said fixing filaments and/or of the granulometry of the aggregates.

According to another particular feature, the filtration opening of said filtering layer is arranged to control the flow of said fluid in the geocomposite as a function of the kinetic fixing speed of the chemical compounds by said fixing filaments and/or of the granulometry of the granulate and/or the aggregates.

According to another particular feature, each of said fixing filaments extends outside said surface as far as at least one attachment device of the fixing filaments, which is accessible to allow replacement of said fixing filaments.

According to another particular feature, said mini-drains are parallel to each other.

According to another particular feature, the system comprises at least one collecting trench made in and/or at the edge of said surface and whereof the bottom is impermeable and located at a height less than that of said surface.

According to another particular feature, said collecting trench is impermeable because of at least one impermeable membrane arranged at the bottom of the trench and rising to the level of said surface, on either side of the trench.

According to another particular feature, said trench terminates on at least one pumping device.

According to another particular feature, said pumping device terminates on at least one conduit discharging fluid outside the aggregates.

According to another particular feature, said pumping device terminates on at least one conduit guiding fluid above the aggregates for successive passes through said system or upstream of the perforated mini-drains for successive passes in the latter.

According to another particular feature, said surface is fitted with at least one substantially impermeable membrane.

Techniques are known for making a difference in permeability.

Another aim of the present invention is also to eliminate at least some disadvantages of the prior art by proposing a collection process of chemical compounds in soils, which is inexpensive, efficacious and which can be used repeatedly by minimising handling.

This aim is achieved by a collection process of chemical compound in aggregates, characterised in that it comprises a step for creating at least one surface on which is arranged at least one geocomposite comprising at least one draining layer on which are arranged perforated mini-drains each containing at least one fixing filament of chemical compound, followed by a deposit step of aggregates on said geocomposite such that fluid, which is loaded with chemical compound(s) when passing through said aggregates, reaches the interior of said perforated mini-drains in which said fixing filaments collect the chemical compound(s).

According to another particular feature, the deposit step of aggregates on said geocomposite is preceded by a deposit step of at least one filtering layer covering the perforated mini-drains, so as to filter said fluid.

According to another particular feature, the deposit step of aggregates on said geocomposite is preceded by a deposit step of at least one granulate of granulometry determined as a function of the kinetic fixing speed of the chemical compounds by said fixing filaments and/or of the granulometry of the aggregates.

According to another particular feature, the process comprises at least one attachment step of each of said fixing filaments to at least one attachment device of the accessible fixing filaments, allowing the execution of at least one replacement step of said fixing filaments.

According to another particular feature, the step for creating said surface is accompanied by at least one step for creating at least one collecting trench, in and/or at the edge of said surface, and whereof at least the bottom is impermeable and located at a height less than that of said surface.

According to another particular feature, said collecting trench is impermeable because of at least one deposit step of at least one impermeable membrane on the walls of the trench and rising to the level of said surface, on either side of the trench.

According to another particular feature, the step for creating said trench comprises a placement step of at least one pumping device of the trench, which terminates on at least one conduit, for enabling execution either of discharge of said fluid outside the aggregates, or resprinkling of said fluid above the aggregates, or recirculation of said fluid in the perforated mini-drains.

According to another particular feature, the process is conducted in a system according to the invention.

Other particular features and advantages of the present invention will emerge more clearly from the description hereinbelow, given in reference to the attached drawings, in which:

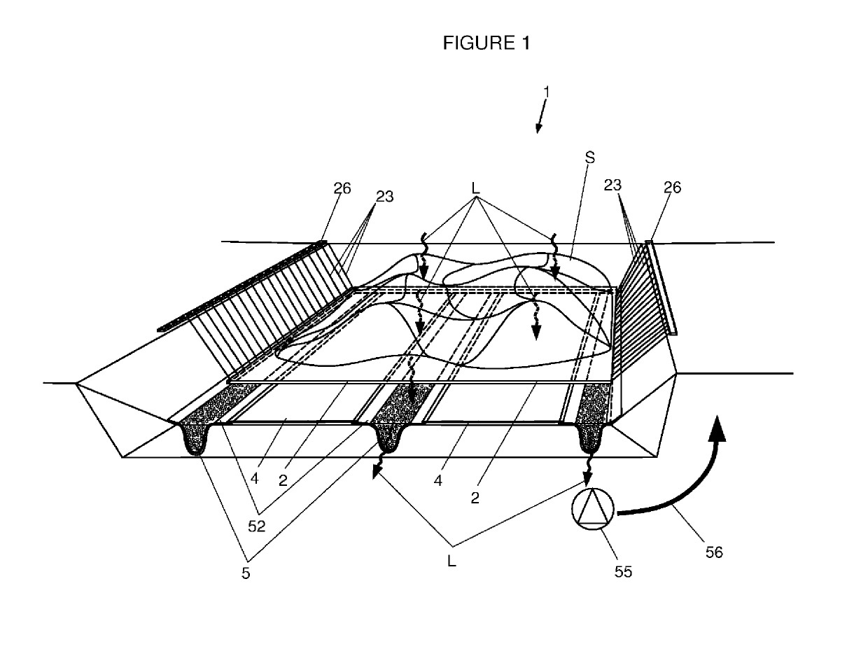

FIG. 1 illustrates a perspective view of a system according to some embodiments of the invention,

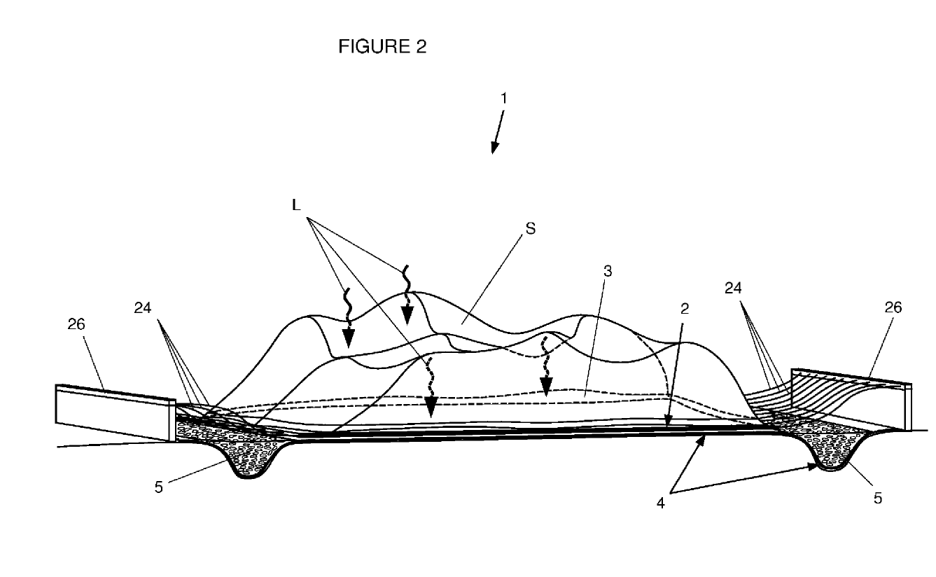

FIG. 2 illustrates a perspective view of a system according to other embodiments of the invention,

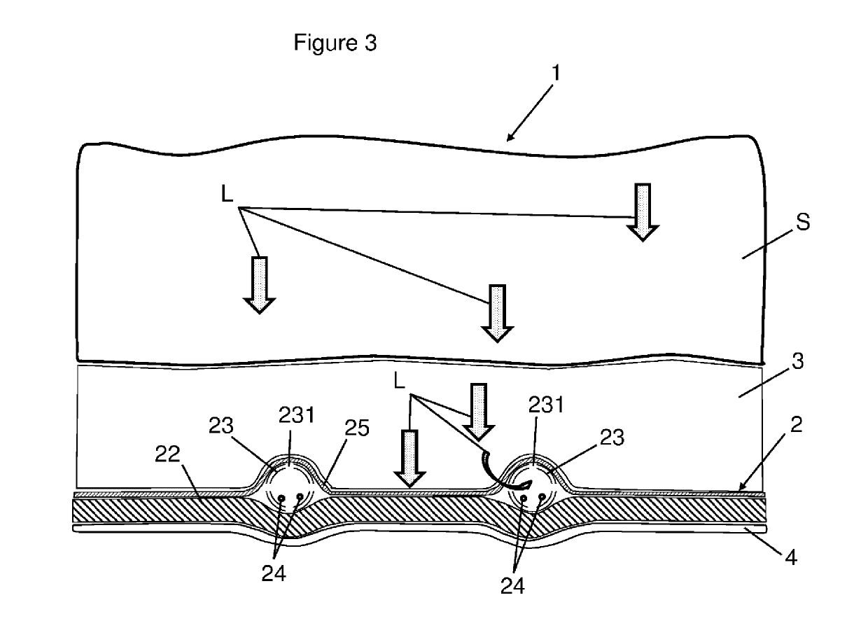

FIG. 3 illustrates a sectional view of part of a geocomposite, covered by a granulate and aggregates, in a system according to some embodiments of the invention,

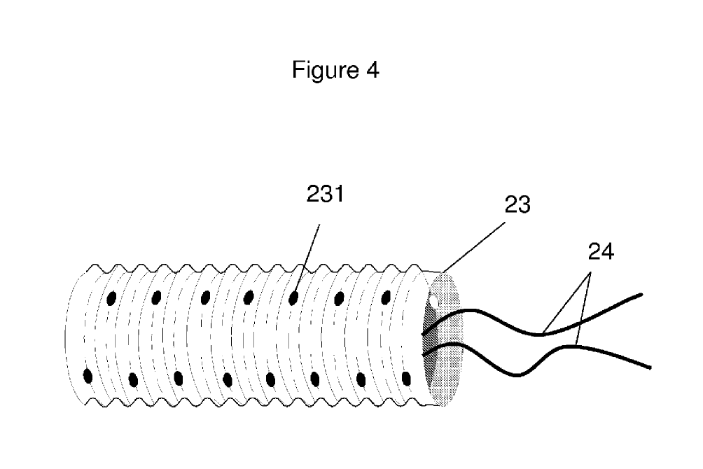

FIG. 4 illustrates a perspective view of part of a mini-drain used in a geocomposite of a system according to some embodiments of the invention, with fixing filaments exceeding the mini-drain,

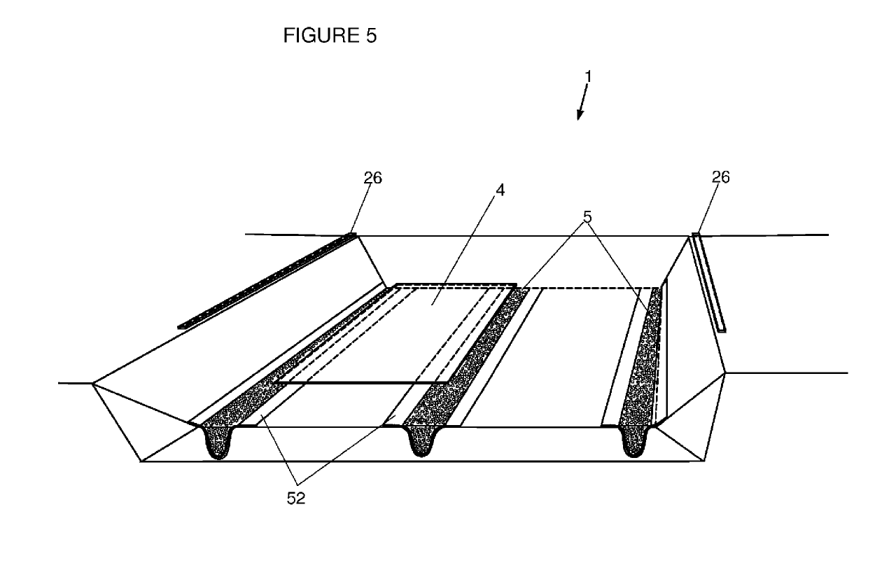

FIG. 5 illustrates a perspective view of part of a system while it is being placed according to some embodiments of the invention,

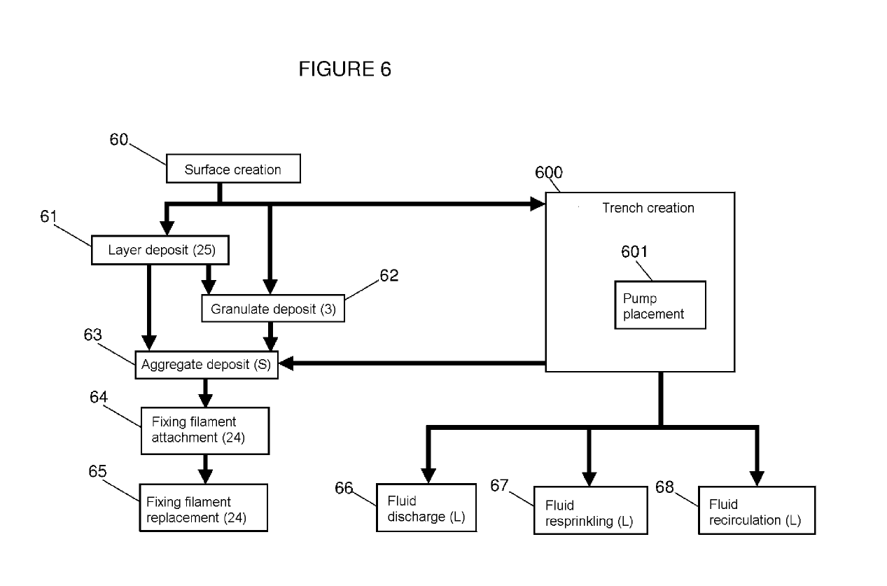

FIG. 6 illustrates the steps of a collection process of chemical compound according to some embodiments of the invention.

The present invention relates to a system (1) and a process for collection (capture) of chemical compound(s), in particular in aggregates. The term “aggregate” is used here in its general sense of “combination of a set of distinct elements, identical or different in nature”. This term is used in the plural to mean that it optionally combines numerous elements, but can consist of a single type of aggregate, with this aggregate containing a single type of element or several heterogeneous elements. This term therefore generally covers the definition of soils, sediments, sludge or waste. For example, this aggregate could in fact be soil in which a trench (dugout) has been made to implement the present invention. The person skilled in the art will understand from reading the present application that this term is not limited to the examples provided here and that the invention can be used for any type of elements, provided that percolation is possible through the element or the elements in which the chemical compounds to be collected are present. In fact, the present invention is particularly efficacious for decontamination of soils and can be used for decontamination of waste, especially buried discharges, for example. The present invention can also be used in the field of mining (mining field), especially for collecting valuable chemical compounds, such as for example precious metals. Fluids, especially water, which percolate through the aggregates (soils, sediments, waste, etc.) are often polluted as they become loaded with pollutants of various kinds, such that the resulting fluid or percolates must be decontaminated. The present invention capitalises (take advantage) on this phenomenon and therefore allows decontaminating aggregates by using such fluids and decontaminating them. Similarly, in the mining field, fluid which will pass through the aggregates and which will convey the chemical compounds to be extracted can be used, to allow them to be collected (captured, extracted) directly in (from) the fluid. The person skilled in the art will understand that fluids used could for example be rainwater or water sprinkled expressly on the aggregates if needed, or even any other type of fluid which could be selected as a function of the compound or compounds to be collected. one will is generally choose a liquid in which the compounds to be collected are soluble or which at least conveys these compounds through the aggregates in which they are present. It is noted that various types of fluids, mixed or successive, can also be used and that this is not necessarily a single fluid.

The system (1) according to the invention comprises at least one surface on which at least one geocomposite (2) is arranged. This surface could be fitted with at least one substantially impermeable membrane (4), before the geocomposite (2) is placed, to provide a contrast in permeability between said surface and the geocomposite. Indeed, for the geocomposite to fully plays its role in drainage and harvesting (collection) of the fluid, as is detailed in the present application. it is necessary that it has a better permeability than the support on which it is arranged. In this way, a membrane, film or textile less permeable than the geocomposite could be provided. Similarly, the deposit of argillaceous sediments or compacted sediments or any other type of material which will be less permeable than the geocomposite (2) could even be provided so that fluid preferably passes through the geocomposite. In the case of fluids which are not to penetrate the subsoil, a completely impermeable membrane will be used for example, in particular in the case of decontamination of aggregates. This membrane could for example be a membrane made of HDPE (High-Density PolyEthylene) to ensure proper solidity and proper sealing. In the present application the term “impermeable membrane” therefore means these different possibilities, whether this is effectively a membrane or not (sediments, textiles or other) and the impermeability is relative (“substantially”) or total (“completely”). In some embodiments, this surface has at least one slight slope for easier flow of the fluid (L) and its drainage. However, a flat surface without slope is optionally preferred for slow flow allowing better collection of chemical compounds. Also, in some embodiments the invention uses at least one pumping device which improves circulation of fluid in the system and which makes the use of slope(s) on this surface relatively unuseful.

Arranged on this surface made in the soil (for example the soil itself or at the bottom of a pond, as explained in the present application) is at least one geocomposite (2) comprising at least one draining layer (22) on which are arranged perforated mini-drains (23), each containing at least one fixing filament (wire) (24) of chemical compound. The aggregates (S) are deposited on said geocomposite (2) such that fluid (L), which is loaded with chemical compound(s) when passing through the aggregates (S), reaches the interior of said perforated mini-drains (23) in which said fixing filaments (24) collect the chemical compound(s). A given type of filament could optionally fix several compounds at once. It is understood that the term “chemical compounds” is used in the plural but that the invention can be specific to a single type of compound or can specify several compounds at once. In general, the use of the singular or the plural in the present application is not limiting. A plurality of fixing filaments could also be used, with at least one type of filament per preferred compound, for fixing several compounds by the system. For example, devices capable of collecting heavy metals are known. The invention proposes arranging these devices in the form of filaments so they can be placed in the perforated mini-drains (23) inside which they will be exposed to fluid (L) to collect the chemical compound (heavy metal for example) to which they are specific (respectively). Fixing filaments of other compounds can also be provided, but the invention is particularly adapted to fixing metals (especially precious or heavy) in mini-drains. So, at least one fixing filament of lead and at least one fixing filament of zinc, etc. can also be provided, for example.

In some embodiments, the system is in the form of a pond (cavity, basin) as in the example illustrated in FIG. 1. In these embodiments, a cavity is made in the soil, with said surface fitted with the impermeable membrane (4), on which the geocomposite (2) is arranged at the bottom of this cavity. The aggregates (S) (for example soil dug to make the cavity and/or other types of aggregates) are deposited on the geocomposite (2) which drains the fluid (L) in the mini-drains (23). It is noted that there can also be at least one impermeable membrane on the bank forming the edges of this cavity, to prevent leaks of fluid into the soil via the edges of the pond.

In some embodiments, the system is in the form of a platform as in the example illustrated in FIG. 2. In these embodiments, said surface receiving the geocomposite (2) is made of the soil itself, preferably with collecting trenches (5) made at least on the edges of said surface, as explained in the present application. The aggregates (S) are deposited in a heap on the geocomposite.

Said mini-drains (23) are preferably parallel to each other.

In a non-limiting manner, the mini-drains (23) can be distributed such that they are spaced by a distance from 0.2 metres to 4 metres in width of the geocomposite (2), preferably between 0.5 and 2 metres, ideally of the order of a metre.

In some embodiments, the perforated mini-drains (23) have perforations (231) which, instead of being round are oval or oblong to limit resistance to the entry of fluid and limit clogging of perforations (231, FIG. 4). In an illustrative and non-limiting manner, these perforations could have a size of the order of 0.5 millimetres to 2 millimetres, preferably from 0.7 to 1.5 mm, ideally of the order of a millimetre. Also, in some embodiments, the mini-drains are ringed, as illustrated in FIG. 4, to provide better resistance to pressure, which allows them to be buried under a considerable quantity of aggregate. The aim of mini-drains (23) is to collect fluid (L) for drainage. By way of non-limiting illustration they are generally resistant to pressure of up to 750 kPa corresponding to around 60 m in height of aggregates (S) on average above the mini-drain. Mini-drains (23) are resistant to compression, which allows fluids to always be able to be discharged even when the geocomposite (2) is buried under aggregates (in soil, for example). According to various embodiments and in a non-limiting manner, for optimisation of fluid flow, the mini-drains (23) can have diameters of between 5 mm and 50 mm, preferably between 10 mm and 25 mm, ideally of the order of 25 mm. As a function of the number of fixing filaments (and types of fixing filaments) to be used, variable diameters could be provided. However, the diameter of mini-drains must not exceed a certain value for a given composition and arrangement of mini-drains such that they resist the weight of aggregates (S) as mentioned hereinabove.

In some embodiments, said geocomposite (2) comprises at least one filtering layer (25) covering the perforated mini-drains (23), so as to filter said fluid (L). Accordingly, in these embodiments the mini-drains (23) are sandwiched between at least one upper filtering layer (25) and one lower draining layer (22). In some embodiments, a filtering layer (25) is arranged directly on the draining layer (22), below the mini-drains (23). In some embodiments, non-exclusive of the preceding ones, a second filtering layer can be added above the first filtering layer covering the mini-drains (23) to optimise filtration of the fluid. The layers (levels) of filtering layers can also optionally be multiplied, both above and below the mini-drains. In particular for the filtering layers located above the mini-drains, an upper filtering layer having a filtration opening above the lower filtering layer could be selected for example to produce progressive filtering of fluid via the successive layers (levels) of filtering layers. By way of illustration and non-limiting, the filtration opening of a filtering layer (25) used in the invention could be between 40 and 400 μm, preferably between 80 μm and 250 μm, ideally of the order of 120 μm.

The aim of the filtering layers (25) is to protect the draining layer (22) from clogging by fine particles. Such layers consequently have porometry adapted to this function, just as the draining layer has porometry adapted to its function.

It is noted that this term “layer”, which is a conventional term for a geotextile, corresponding in general to entangling of needled filaments which can also be designated by the term “felt”, but it's possible to use other types of coatings, preferably geotextiles such as for example woven non-woven textiles, knitted or not, etc. This term “layer”, conventionally designating a type of textile, must therefore be interpreted as less limiting in the present application, since other types of coating than the layers of geotextiles can be used, even though the latter are particularly adapted to the present invention. In fact, the tangling of needled filaments in general provides degrees of permeability particularly adapted to the present invention but, for adapting the fluid flow (L) to collecting chemical compounds by the fixing filaments (24) present in the mini-drains (23), other types of coating or even combinations of these layers of geotextiles with other coatings can be used.

Also, it is noted that the present application mentions using at least one geocomposite and that several geocomposites can be used. In particular, it is possible to use several superposed geocomposites or a geocomposite comprising a plurality of layers (layers, mini-drains, etc.) such as described in the present application, especially in the event where several specific types of fixing filaments of various types of chemical compounds are desired in the system. In fact, as a function of the kinetic collection speeds, layers having different degrees of permeability could be placed in successive layers of the same geocomposite or superposed geocomposites, the permeability of each layer being adapted to the type of fixing filaments present in its mini-drains. For example, a first layer comprising at least one highly permeable draining layer could contain fixing filaments having a high collection speed, while a less permeable lower layer will retain fluid long in contact with its fixing filaments having a slower collection speed.

In some embodiments, said geocomposite (2) is covered, before deposit of the aggregates (S), with at least one granulate (3) of granulometry determined as a function of the kinetic fixing (collection) speed of chemical compounds by said fixing filaments (24) and/or of the granulometry of the aggregates (S). The presence of the filtering layer (25) generally decreases, for example by half, the thickness of the layer of granulates generally necessary for filtering of the fluid. Optionally, a granulate (3) can even be omitted depending on the type of aggregates, and similarly, the filtering layer can eventually be omitted even though this is rare, since the fine particles would risk blocking the perforations of the mini-drains. However, according to the type of aggregates, depositing a plurality of granulates (3) on the geocomposite (2), with precisely selected granulometries, produces retention of the finest particles by the largest and a filter can be formed by a succession of different granulates, but the use of a filtering layer which simplifies the arrangement is preferred. In general, the filtration opening of said filtering layer (25) is arranged to control the flow of fluid (L) in the geocomposite (2). This filtration opening can be adapted as a function of the kinetic fixing speed of the chemical compounds by said fixing filaments (24). It can also be adapted as a function of the granulometry of the granulate (3).

It can also be adapted as a function of the granulometry and/or of the composition of the aggregates (S). In general, the filtering layer (25) is provided as a function of all these factors so as to control flow in the mini-drains (23). The height of fluid (L) (and therefore the pressure exerted) in the geocomposite is considerable for penetration of the fluid into the mini-drains (23) and must be adapted to the kinetic fixing speed of the chemical compounds by the fixing filaments (24). In fact, for example in the case of fixing filaments of heavy metals, the ionic exchange speed determines the flow of fluid which the geocomposite must be able to drain. It is noted that when several types of specific fixing filaments of different heavy metals for example are provided the flow is generally adapted to the lowest speed of exchange of these various types of fixing filaments (24). According to the kinetic speed of the collection of compounds in the mini-drains, the flow speed could be regulated by the dimensioning of the filtration opening of the filtering layer (25) and/or of the drainage opening of the draining layer (22). So, the dimensioning of the constituents of the geocomposite (2) is decisive for flow and for collection of compounds in the mini-drains. The filtering layer is preferably arranged to filter fluid and calibrate particles which enter the geocomposite, whereas the draining is preferably arranged for easier circulation of the fluid in the geocomposite. These two layers will therefore have different openings, adapted respectively to their function.

In some embodiments of the invention, each of said fixing filaments (24) present in the mini-drains extends beyond said surface as far as at least one attachment device (26) of the fixing filaments (24), accessible so as to allow replacement of said fixing filaments (24). In some embodiments, it is the complete mini-drains (23) which extend beyond the geocomposite (2) and the surface so as to protect the filaments as far as the attachment device (26), as for example illustrated in FIG. 1, but it can be that the mini-drains (23) stop in the geocomposite (2) and that only the filaments (24) extend out, such as illustrated in FIG. 2 for example, or enveloped in another protective element (not illustrated).

Therefore, as illustrated both in FIG. 1 and FIG. 2, an easily accessible attachment device (26) can be provided, for example arranged outside the soil. Once the fixing filaments (24) are saturated in chemical compound, they can easily be replaced to continue use of the system according to the invention. Similarly the reuse of the system is made easier when the aggregates have been sufficiently exploited or decontaminated since it suffices to withdraw the latter to then reuse it, replacing the fixing filaments if needed whether this is before or after replacement of the aggregates.

In some embodiments of the invention, the system comprises at least one collecting trench (5), made in and/or at the edge of said surface, and whereof the bottom is impermeable and located at a height less than that of said surface, as illustrated in FIGS. 1 and 2 for example. As mentioned previously, the mini-drains are preferably parallel to each other and the trenches (5) are preferably perpendicular to the mini-drains. A given distribution of the trenches (5) will be selected, preferably regular, as a function of the permeability of the aggregates and/or of the type of fluid and/or of the collection speed of the compounds, so that the mini-drains are bathed in an optimal quantity of fluid for the collection of chemical compounds. In some embodiments of the invention, said collecting trench (5) is impermeable because of an impermeable membrane (52), for example made of HDPE, which prevents percolation of the fluid in the subsoil. In some embodiments, as in the example illustrated in FIG. 1, this membrane is arranged at the bottom of the trench (5) and rises to the level of said surface, on either side of the trench (5). In this case, it can be provided that the impermeable membrane (4) covering said surface extends at least as far as near the trenches, above the impermeable membrane (52) covering the walls of the trenches or it can be provided that it is welded to the latter, as in the example of FIG. 1, or that it extends entirely as far as the trench to terminate therein, as illustrated in FIG. 5. It is noted that in the various possible embodiments of the invention the impermeable membrane (4) which covers said surface could be integrated into the geocomposite (2) which will then comprise a lower impermeable surface. However, in the majority of the embodiments, it is preferable to separate the impermeable membrane (4) from the geocomposite (2), especially for easier manufacture of the geocomposite (especially in the case of needled non-woven layers which would require later addition of an impermeable membrane) and because of the drainage of the fluid. In fact, collecting trenches are made under the geocomposite (2) for collecting fluid in determined spaces and these trenches must comprise an impermeable bottom, generally obtained because of at least one impermeable membrane (52) deposited at the bottom of the trench. Thus, only a single impermeable membrane (4) arranged on said surface and fitting the bottom of the trenches can rather be used, for example as illustrated in FIG. 2. In this way, the fluid is drained by the geocomposite (2) above the impermeable membrane (4) and naturally enters at the bottom of the impermeable trenches. As mentioned previously, a contrast in permeability can be made between the geocomposite and the support on which it is arranged, other than by the use of a real membrane (this term must not be interpreted as limiting). The same applies for the trenches. The term impermeable membrane is used here in general, but it must be understood that impermeability can be relative or total and that it can concern types of coating other than a membrane, as explained for the “membrane” (4) optionally covering the surface which receives the geocomposite (2). So, although FIGS. 1, 2, 3 and 5 illustrate such membranes (4, 52), they could be omitted or replaced by other arrangements.

FIG. 5 shows the use of such trenches (5), prior to deposit of the geocomposite (2), with the impermeable membrane (52) spilling over onto said surface and with the impermeable membrane (4) covering said surface by straddling the edges of this impermeable membrane (52) of the trenches (5).

In some embodiments, a granulate is added to the trenches allowing the trench to be filled and/or the flow of the fluid in the trench to be regulated, as illustrated for example in FIGS. 1, 2 and 5.

In some embodiments of the invention, said trench (5) terminates on at least one pumping device (55). Collecting drains (of diameter greater than that of the mini-drains) are preferably used in the trenches to harvest fluid drained by the geocomposite, and these collecting drains (not illustrated) are connected to the pumping device(s) (which can be outside the trench, as long as it is capable of pumping fluid from the trench). According to various embodiments, said pumping device (55) terminates on at least one conduit (56) discharging the fluid (L) outside the aggregates (S) or terminates on at least one conduit (56) guiding the fluid (L) above the aggregates (S) for successive passes through said system (1) or upstream of the perforated mini-drains (23) for successive passes in the latter. A device for measuring the content of heavy metals and/or ionic exchange could be arranged at the end of at least some mini-drains and/or in the collecting trenches to determine whether the filaments are saturated and whether they need to be changed and/or determine whether the fluid in the drains and/or in the aggregates must be recirculated.

The draining layer (22) and the filtering layer (25) are preferably non-woven. In some embodiments of the invention, the draining (22) and filtering (25) layers are needled non-wovens. These two layers are preferably interconnected by the needling technique. Perforated mini-drains (23), preferably ringed, whereof the perforations alternate at approximately 90° are arranged on the draining layer (22), parallel to each other at distances selected as a function of the destination of the geocomposite (2). Each narrow section of the flutes (grooves) of a (ringed) mini-drain (23) is preferably fitted with two diametrically opposed perforations (231) and the perforations (231) of two successive narrow sections are offset to each other by 90°. In some embodiments, this layer of mini-drains (5) is covered by a needled non-woven filtering layer (31). During needling of the layers, spaces can be provided for placing the mini-drains (23). These mini-drains (23) are consequently connected to the structure of the geocomposite (2) since they are already placed between the layers during needling.

The inter-layer connection made by needling gives the geocomposite (2) several qualities. In fact, this way of connecting the layers offers a geocomposite having increased internal resistance to shearing. This resistance is such that the geocomposite (2) can be used for drainage of sloping banks. The needling connection also offers a geocomposite (2) whereof the filtering faces have uniform and constant porometry. A geocomposite (2) whereof the connections are made by needling has increased solidity to laying and during use, since stresses undergone apply to the whole mass and not to a few precise points of the structure. Finally, the filtering quality of the geocomposite (2) is not altered, as is the case for connection via adhesion or sewing.

The different elements comprising the geocomposite (2) are preferably constituted by non-perishable materials such as for example polypropylene. In general, the draining (22) and filtering (25) layers, as well as the mini-drains (23), are preferably resistant to acidic or basic medium.

Often, especially in the field of waste storage, it is necessary to collect the fluid produced by this waste or fluids produced when waste is sprinkled by at least one fluid which can be water and/or solvent and/or acid, for example. It is noted that the term “fluid” is used in the present application in the same way, whatever this fluid being added to the aggregates (S) or produced by them. This fluid percolates for example at the bottom of the bins (cavities) in which the waste is stored, for recovery (collection) by a discharge system so that it does not enter the soil in which the waste is buried. However, the fluid coming from waste can be loaded with bacteriological and fungicidal particles which, in the long term, can clog the geocomposite (2). The consequence of this is to stop fluid from passing through and make the geocomposite (2) in effective. In some embodiments, to rectify this problem at least the upper filtering layer (25) is composed of fibres which have been extruded with at least one antibacterial and/or bactericidal and/or fungicidal active ingredient. This active ingredient can be embedded in the fibres so as to be present on the surface of the fibres and at the centre of the fibres. This distribution allows medium-term and long-term migration of the antibacterial and/or bactericidal and/or fungicidal agents to the surface of the fibres, making the product efficacious in the long-term.

The layers, or at least the filtering layers (25), are preferably composed by fibres of large diameter. This diameter corresponds for example to titering of fibres or a mass per unit length of the filaments of between 4 dtex (or “dtx”, abbreviation of decitex) and 110 dtex given that 1 dtex corresponds to 1 mg of matter making up the fibres for 1 m of fibre. This produces a wide filtration opening and a permeability speed component normal to the plane of the geocomposite (2) which is large enough for it to influence the contact duration between the geocomposite (2) and the fluid. Reducing this contact duration in the filtering layer, reduces clogging due to bacteria or fungi. The drained fluid accumulates in the mini-drains where the contact duration will be sufficient for the fixing filaments (24) to collect the chemical compounds.

It is therefore understood that the present invention relates to a system which allows collection of chemical compounds, especially heavy or precious metals, in aggregates in general, and in particular soils, waste, sediments, sludge, etc.

According to the invention, it suffices to deposit the aggregates on the system and to let fluid percolate through the aggregates. The fluid can be water, such as rainwater in general, but can also be modified, for example to make water acidic or it can vary in nature. In the case of buried discharges, when they are being retreated, the waste and the fines are discharged (residual organic components), especially for screening and recovery in the best of cases. The invention allows for non-polluting reuse of the discharge zone by arranging a system according to the invention at the bottom of the latter which will run autonomously, without clogging and will eliminate numerous pollutants. The fact that the fixing filaments can be replaced easily is also an advantage, especially in this field as buried discharges are generally provided for a sedimentation duration of several years, or even tens of years.

The person skilled in the art knows from the present description that circulation of the fluid in the system is an important factor and that various parameters influence this circulation. The circulation will be regulated in general as a function of the kinetic speed collection of chemical compounds. For this, said surface can be arranged such that it has a slight slope, preferably parallel to the orientation of the mini-drains and perpendicular to the trenches, but a non-sloped flat surface is generally preferred to regulate circulation with the properties of the geocomposite and/or pumping of the in the trenches. Similarly, the bottom of the trenches can be sloping or not and the pumping in the trenches can be arranged due to collecting drains and/or granulates in the trenches and/or to distribution of several pumping devices.

The invention therefore provides a process for implementing such a system and enabling collection of chemical compounds which is followed by percolation of fluid. The process could naturally comprise at least one sprinkling step (single or repeated as needed) of at least one type of fluid on the aggregates deposited on the system, but this step is optional because fluid can be obtained from rainwater or, especially in the case of waste, be produced directly by the aggregates themselves, as mentioned previously. An embodiment of the process is illustrated schematically in FIG. 6, showing the majority of possible steps of the process, even some optional steps.

The process can be carried out in a system according to the invention. The collection process of chemical compound in aggregates (S) comprises a step for creating (60) at least one surface fitted with at least one impermeable membrane on which at least one geocomposite (2) is arranged, comprising at least one draining layer (22) on which perforated mini-drains (23) are arranged, each containing at least one fixing filament (24) of chemical compound. A deposit step (63) of aggregates (S) on said geocomposite (2) allows fluid (L), which is loaded with chemical compound when passing through said aggregates (S), to reach the interior of said perforated mini-drains (23) in which said fixing filaments (24) collect the chemical compound(s).

In some embodiments, the deposit step (63) of the aggregates (S) on said geocomposite (2) is preceded by a deposit step (61) of at least one filtering layer (25) covering the perforated mini-drains (23), so as to filter said fluid (L).

In some embodiments, the deposit step (63) of the aggregates (S) on said geocomposite (2) is preceded by a deposit step (62) of at least one granulate (3) of granulometry determined as a function of the kinetic fixing speed of the chemical compounds by said fixing filaments (24) and/or of the granulometry of the aggregates (S).

In some embodiments, the process comprises at least one attachment step (64) of each of said fixing filaments (24) to at least one attachment device (26) of the accessible fixing filaments (24), allowing at least one replacement step (65) of said fixing filaments (24) to be carried out.

In some embodiments, the step for creating (60) said surface is accompanied by at least one step for creating (600) of at least one collecting trench (5), in and/or at the edge of said surface, and whereof at least the bottom is impermeable and located at a height (level) less than that of said surface. In some of these embodiments, said collecting trench (5) is impermeable because of at least one deposit step of at least one impermeable membrane (52) on the walls of the trench (5) and rising to the level of said surface, on either side of the trench (5).

According to various embodiments, the step for creating said trench (5) comprises a placement step (601) of at least one pumping device (55) of the trench, terminating on at least one conduit (56) to allow the use, or discharge (66) of the fluid (L) outside the aggregates (S), or resprinkling (67) of the fluid (L) above the aggregates (S), or recirculation (68) of the fluid (L) in the perforated mini-drains (23).

The present application describes various technical characteristics and advantages in reference to the figures and/or to various embodiments. The person skilled in the art will understand that the technical characteristics of a given embodiment can in fact be combined with characteristics of another embodiment unless expressed otherwise or unless it is evident that these characteristics are incompatible. Also, the technical characteristics described in a given embodiment can be isolated from other characteristics of this mode unless expressed otherwise.

It must be evident for the person skilled in the art that the present invention allows embodiments in numerous other specific forms without departing from the field of application of the invention as claimed. Consequently, the present embodiments must be considered by way of illustration, but can be modified in the field defined by the scope of the attached claims, and the invention must not be limited to the details given hereinabove.

1. A collection system of chemical compound in aggregates, the collection system comprises at least one surface on which is arranged at least one geocomposite comprising at least one draining layer on which are arranged perforated mini-drains each containing at least one fixing filament of chemical compound, aggregates being deposited on said geocomposite such that fluid, which is loaded with chemical compound when passing through the aggregates, reaches the interior of said perforated mini-drains in which said fixing filaments collect the chemical compound.

2. The system according to claim 1, wherein said geocomposite comprises at least one filtering layer covering the perforated mini-drains for filtering said fluid.

3. The system according to claim 1, wherein said geocomposite is covered, prior to deposit of the aggregates, by at least one granulate of granulometry determined as a function of the kinetic fixing speed of the chemical compounds by said fixing filaments and/or of the granulometry of the aggregates.

4. The system according to claim 1, wherein the filtration opening of said filtering layer is arranged to control the flow of said fluid in the geocomposite as a function of the kinetic fixing speed of the chemical compounds by said fixing filaments and/or of the granulometry of the granulate and/or the aggregates.

5. The system according to claim 1, wherein each of said fixing filaments extends outside said surface as far as at least one attachment device of the fixing filaments, accessible so as to allow replacement of said fixing filaments.

6. The system according to claim 1, wherein said mini-drains are parallel to each other.

7. The system according to claim 1, the system further comprises at least one collecting trench, made in and/or at the edge of said surface, and whereof the bottom is impermeable and located at a height less than that of said surface.

8. The system according to claim 1, wherein said collecting trench is impermeable because of at least one impermeable membrane arranged at the bottom of the trench and rising to the level of said surface, on either side of the trench.

9. The system according to claim 1, wherein said trench terminates on at least one pumping device.

10. The system according to claim 9, wherein said pumping device terminates on at least one conduit discharging fluid outside the aggregates.

11. The system according to claim 9, wherein said pumping device terminates on at least one conduit guiding fluid above the aggregates for successive passes through said system or upstream of the perforated mini-drains for successive passes in the latter.

12. The system according to claim 1, wherein said surface is fitted with at least one substantially impermeable membrane.

13. A collection process for chemical compound in aggregates, the process comprises a step for creating at least one surface on which is arranged at least one geocomposite comprising at least one draining layer on which are arranged perforated mini-drains each containing at least one fixing filament of chemical compound, followed by a deposit step of aggregates on said geocomposite such that fluid, which is loaded with the chemical compound when passing through said aggregates, reaches the interior of said perforated mini-drains in which said fixing filaments collect the chemical compound.

14. The process according to claim 13, wherein the deposit step of the aggregates on said geocomposite is preceded by a deposit step of at least one filtering layer covering the perforated mini-drains, so as to filter said fluid.

15. The process according to claim 13, wherein the deposit step of the aggregates on said geocomposite is preceded by a deposit step of at least one granulate of granulometry determined as a function of the kinetic fixing speed of the chemical compounds by said fixing filaments and/or of the granulometry of the aggregates.

16. The process according to claim 13, the process further comprises at least one attachment step of each of said fixing filaments to at least one attachment device of the accessible fixing filaments, allowing the execution of at least one replacement step of said fixing filaments.

17. The process according to claim 13, wherein the step for creating said surface is accompanied by at least one step for creating of at least one collecting trench, in and/or at the edge of said surface, and whereof at least the bottom is impermeable and located at a height less than that of said surface.

18. The process according to claim 13, wherein said collecting trench is impermeable because of at least one deposit step of at least one impermeable membrane on the walls of the trench and rising to the level of said surface, on either side of the trench.

19. The process according to claim 13, wherein the step for creating said trench comprises a placement step of at least one pumping device of the trench which terminates on at least one conduit, to allow the use or discharge of said fluid outside the aggregates, or resprinkling of said fluid above the aggregates, or recirculation of said fluid in the perforated mini-drains.

20. The process according to claim 13, the process being used in a system according to claim 1.
